(19) United States
(12) Patent Application Publication
(10) Pub. No.: US 2026/0046539 A1
(43) Pub. Date: Feb. 12, 2026

(54) HYBRID FIBER-COAXIAL (HFC) NETWORK TOPOLOGY DISCOVERY

(71) Applicant: Applied Optoelectronics, Inc., Sugar Land, TX (US)

(72) Inventors: Ramesh NALLUR, Duluth, GA (US); Rafael CELEDON, Atlanta, GA (US); Yi WANG, Katy, TX (US); Vivek SRIVASTAV, Suwanee, GA (US)

(21) Appl. No.: 19/294,762

(22) Filed: Aug. 8, 2025

Related U.S. Application Data
(60) Provisional application No. 63/681,586, filed on Aug. 9, 2024.

(51) Int. Cl. H04Q 11/00

(52) U.S. Cl. CPC H04Q 11/0062; H04Q 11/0003; H04Q 2011/0079; H04Q 2213/13012; H04Q 2213/13196

(57) ABSTRACT

Systems and methods for topology discovering in a hybrid fiber-coaxial (HFC) network use multicast messaging to HFC devices, such as RF amplifiers, to initiate and perform topology discovery. HFC devices receiving a multicast message send advertisement messages upstream with at least a device unique identifier and listen for advertisement messages received from downstream HFC devices. Messaging may be implemented using low data rate, low power bidirectional communications with and between HFC devices, for example, according to the LoraWAN® remote multicast setup specification TS005. One or more HFC devices that receive device unique identifiers from downstream HFC devices maintain a list of those device unique identifiers. List(s) of HFC devices may be provided to a headend controller and/or a node gateway to compile and maintain topology information, for example, to provide a visual representation of the topology.

### CROSS-REFERENCE TO RELATED APPLICATIONS

This application claims the benefit of U.S. Provisional Patent Application Ser. No. 63/681,586, filed on Aug. 9, 2024, which is fully incorporated herein by reference.

### TECHNICAL FIELD

The present application relates generally to hybrid fiber-coaxial (HFC) networks and, more particularly, to systems and methods for topology discovery in HFC networks.

### BACKGROUND

Broadband communication networks are used to provide high speed, high bandwidth transmissions over communication paths to and from devices in the network. In some broadband networks, such as hybrid fiber-coaxial (HFC) networks used for CATV, at least a portion of the communication path includes coaxial cables that carry both downstream and upstream radio frequency (RF) signals. In a CATV network, for example, the downstream RF signals may include video and IP data transmitted from a headend of the HFC network to subscriber devices and the upstream RF signals may include control and IP data transmitted from subscriber devices to the headend. Monitoring and maintaining network devices in an HFC network may present challenges.

In an HFC network, for example, the coaxial distribution network may include RF amplifiers to extend the transmission distance of the RF signals and thus extend the reach of the CATV services provided to subscriber locations. These RF amplifiers are often deployed in a cascading chain, and the sequence of an RF amplifier in the chain may be important because an amplifier failure at some locations may have a bigger impact than others. Establishing the relative importance of an RF amplifier based on its placement in the chain could aid the cable operators in prioritizing and assessing the service impact of the amplifiers.

### SUMMARY

Consistent with an aspect of the present disclosure, a method is provided for topology discovery in a hybrid fiber-coaxial (HFC) network. The method includes: sending, from a topology discovery device, a multicast message downstream to a plurality of HFC devices connected in a cascading chain in the HFC network to initiate a topology discovery mode; sending advertisement messages upstream from the HFC devices in response to receiving the multicast message, wherein each of the advertisement messages includes at least a device unique identifier for the HFC device sending the advertisement message; listening, at the HFC devices that send advertisement messages, for the advertisement messages sent upstream from downstream HFC devices; and maintaining a list of device unique identifiers based on the advertisement messages received from downstream HFC devices.

Consistent with another aspect of the present disclosure, a system is provided for topology discovery in a hybrid fiber-coaxial (HFC) network. The system includes a topology discovery device configured to send a multicast message downstream in the HFC network to initiate a topology discover mode and a plurality of HFC devices connected in a cascading chain in the HFC network. Each of the HFC devices include at least one transponder configured to send advertisement messages upstream from the HFC device in response to receiving the multicast message. Each of the advertisement messages includes at least a device unique identifier for the HFC device sending the advertisement message. The transponder is also configured to listen for the advertisement messages sent upstream from downstream HFC devices and to maintain a list of device unique identifiers based on the advertisement messages received from downstream HFC devices.

### BRIEF DESCRIPTION OF THE DRAWINGS

Reference should be made to the following detailed description which should be read in conjunction with the following figures, wherein like numerals represent like parts.

FIG. 1 is a schematic diagram of a hybrid fiber-coaxial (HFC) network used for CATV, consistent with the present disclosure.

FIG. 2 is a schematic diagram of a remote PHY (R-PHY) HFC network, consistent with the present disclosure.

FIG. 3 is a schematic diagram of an RF amplifier including electronic amplifier circuitry and a transponder for low data rate, low power, bidirectional transmissions, consistent with embodiments of the present disclosure.

FIG. 4 is a schematic diagram of an HFC network with RF amplifiers deployed in a cascading chain, consistent with the present disclosure.

FIG. 5 is a schematic diagram of a system for topology discovery in an HFC network, consistent with embodiments of the present disclosure.

FIG. 6 is a schematic diagram of transponders configured for bi-directional communication to provide topology discovery in an HFC network, consistent with the present disclosure.

FIG. 7 is a flowchart illustrating an embodiment of a method for topology discovery in an HFC network, consistent with an embodiment of the present disclosure.

FIG. 8 is a block diagram illustrating a multicast key derivation scheme for an example of a multicast session setup for topology discovery over an encrypted session, consistent with an embodiment of the present disclosure.

### DETAILED DESCRIPTION

Systems and methods for topology discovering in a hybrid fiber-coaxial (HFC) network, consistent with the present disclosure, use multicast messaging to HFC devices, such as RF amplifiers, to initiate and perform topology discovery. HFC devices receiving a multicast message send advertisement messages upstream with at least a device unique identifier and listen for advertisement messages received from downstream HFC devices. Messaging may be implemented using low data rate, low power bidirectional communications with and between HFC devices, for example, according to the LoraWAN® remote multicast setup specification TS005. One or more HFC devices that receive device unique identifiers from downstream HFC devices maintain a list of those device unique identifiers. List(s) of HFC devices may be provided to a headend controller and/or a node gateway to compile and maintain topology information, for example, to provide a visual representation of the topology.

The systems and methods for topology discovery in an HFC network may be implemented using relatively low-noise communications with or between HFC network devices. Using low noise communications for topology discover minimizes signal interference, ensuring reliable communication and data transmission in the HFC network. By reducing noise, networks can maintain higher signal-to-noise ratios, improving the quality of transmitted information and overall network performance. Thus, the topology discovery, consistent with embodiments of the present disclosure, avoids generating a lot of noise and collision in the network.

As used herein, “channel” refers to a sub-range of frequencies within a spectrum of frequencies, which are capable of being modulated to carry information and a “channel” may be identified as a single frequency in the sub-range of frequencies. As used herein, “primary communication channel” refers to a channel in a defined telecommunications frequency band (e.g., a CATV channel) and a “primary signal” refers to a signal transmitted using a primary communication channel. As used herein, a “downstream primary signal” (also referred to as a forward primary signal) is primary signal being sent from a source, such as a CATV headend/hub, to a destination, such as a CATV subscriber and an “upstream primary signal” (also referred to as a reverse primary signal) is a primary signal being sent from a destination, such as the CATV subscriber, to a source, such as the CATV headend/hub.

As used herein, “low data rate” refers to a data rate that is lower than the data rate of the primary signals on the primary communication channels and “low power” refers to a signal power that is lower than the signal power of the primary signals on the primary communication channels. For example, the “low data rate” may be in the range of 5 kbps to 100 kbps and the “low power” may be between −10 dBm and 0 dBm. Low data rate, low power transmissions may be provided over existing physical communication media (e.g., coaxial cables and/or optical fiber) and in the presence of higher bandwidth, higher power primary signals currently being transmitted over the communication media. The low data rate, low power, bi-directional transmissions may be accomplished using modulated signals that are positioned in frequency relative to the primary signals, such that the low data rate, low power transmissions occur without detectable interference with the primary signals, which include multiplexed narrowband modulated signals.

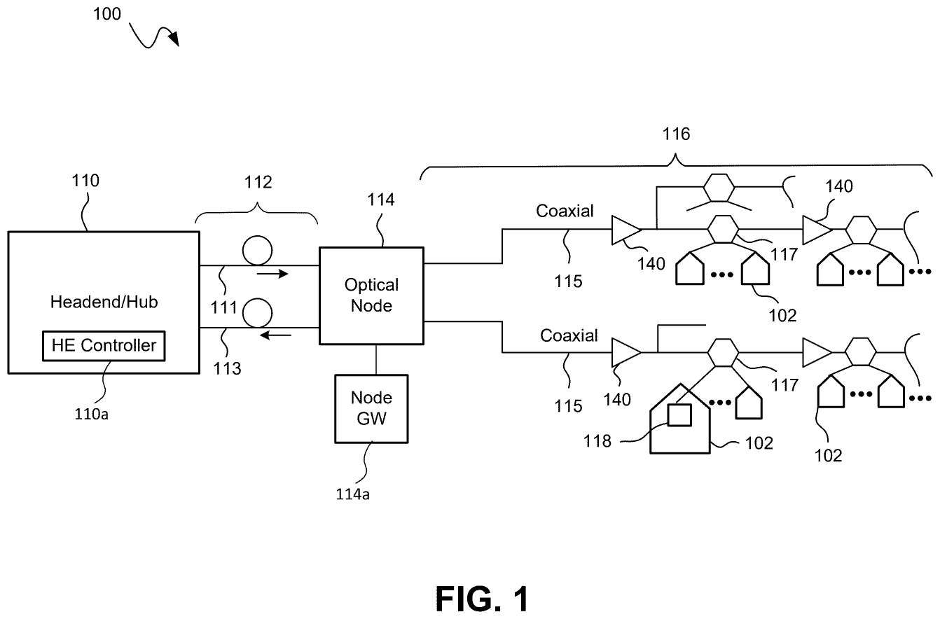

FIG. 1 illustrates an example of a hybrid fiber-coaxial (HFC) network 100 used for CATV, which may implement topology discovery, consistent with embodiments of the present disclosure. In general, the HFC network 100 is capable of delivering both cable television programming (i.e., video) and IP data services (e.g., internet and voice over IP) to customers or subscriber locations 102 through the same fiber optic cables and coaxial cables (i.e., trunk lines). The node(s) 114, line extender RF amplifiers 140, and/or other HFC network devices in the HFC network 100 may include transponders used to perform topology discovery, as will be described in greater detail below.

Multiple cable television channels and IP data services (e.g., broadband internet and voice over IP) may be delivered together simultaneously in the HFC network 100 by transmitting signals using frequency division multiplexing over a plurality of physical channels across a CATV channel spectrum. One example of the CATV downstream channel spectrum (also referred to as forward spectrum) includes channels from 650 MHz to 1794 MHz, but the CATV channel spectrum may be expanded even further to increase bandwidth for data transmission. In a CATV channel spectrum, some of the physical channels may be allocated for cable television channels and other physical channels may be allocated for IP data services. Other channel spectrums and bandwidths may also be used and are within the scope of the present disclosure.

In addition to the primary signals being carried downstream (also referred to as forward signals) to deliver the video and IP data to the subscriber locations 102, the HFC network 100 may also carry primary signals (e.g., IP data or control signals) upstream from the subscribers (also referred to as reverse signals), thereby providing bi-directional communication over the trunks. According to one example, the signal spectrum for the reverse signals carried upstream may be up to 600 MHz.

The HFC network 100 generally includes a headend/hub 110 connected via optical fiber trunk lines 112 to one or more optical nodes 114, which are connected via a coaxial cable distribution network 116 to customer premises equipment (CPE) 118 at subscriber locations 102. The headend/hub 110 receives, processes, and combines the content (e.g., broadcast video, narrowcast video, and internet data) to be carried over the optical fiber trunk lines 112 as optical signals. The headend/hub 110 may include a master headend and/or a regional hub site. The optical fiber trunk lines 112 include forward path optical fibers 111 for carrying downstream optical signals from the headend/hub 110 and return or reverse path optical fibers 113 for carrying upstream optical signals to the headend/hub 110. The optical nodes 114 provide an optical-to-electrical interface between the optical fiber trunk lines 112 and the coaxial cable distribution network 116. The optical nodes 114 thus receive downstream optical signals and transmit upstream optical signals and transmit downstream (forward) RF electrical signals and receive upstream (reverse) RF electrical signals.

The cable distribution network 116 includes coaxial cables 115 including trunk coaxial cables connected to the optical node(s) 114 and feeder coaxial cables connected to the trunk coaxial cables. Subscriber drop coaxial cables are connected to the distribution coaxial cables using taps 117 and are connected to customer premises equipment 118 at the subscriber locations 102. The customer premises equipment 118 may include set-top boxes for video and cable modems for data. One or more line extender RF amplifiers 140 may also be coupled to the coaxial cables of the cable distribution network 116 for amplifying the forward signals (e.g., CATV signals) being carried downstream to the subscriber locations 102 and for amplifying the reverse signals being carried upstream from the subscriber locations 102.

Low data rate, low power, bi-directional transmissions may be implemented, for example, to communicate with or between a node 114 and/or line extender RF amplifiers 140 in the HFC network 100. The HFC network 100 may provide low data rate, low power, bi-directional communications (e.g., using LoRa technology and communication protocols defined by the LoRaWAN® standard) between the headend/hub 110, the nodes 114 and/or amplifiers 140 together with the downstream and upstream primary signals, which have a higher bandwidth and power. Low data rate, low power, bi-directional transmissions may be used for topology discovery consistent with embodiments of the present disclosure. Topology discovery may be initiated, for example, using a headend controller 110a at the headend/hub 110 and/or using a node gateway 114a coupled to an optical node 114. The line extender RF amplifiers 140 and other HFC network devices may include transponders to implement the topology discovery, as will be described in greater detail below.

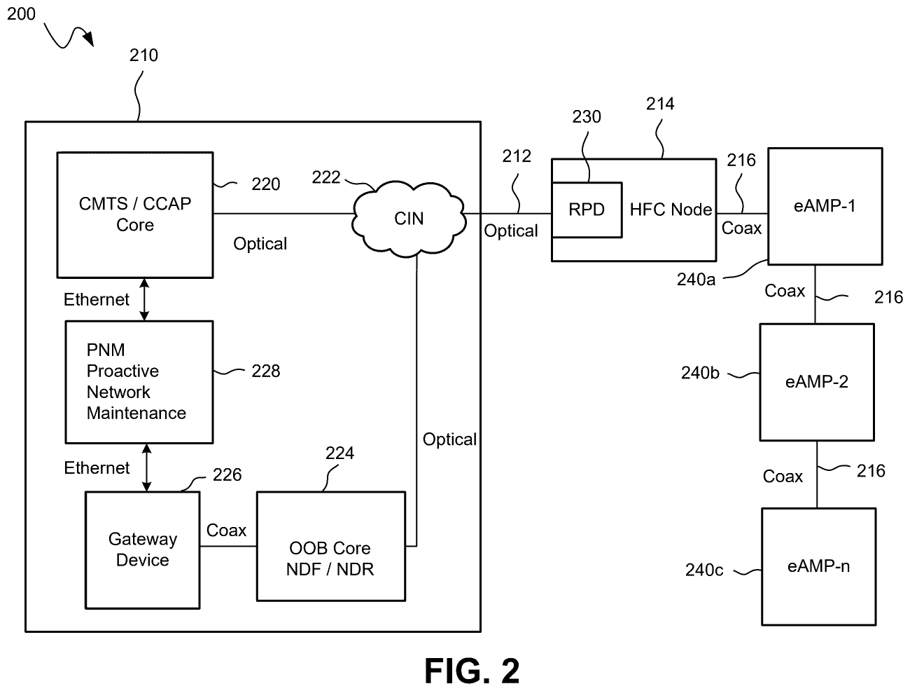

FIG. 2 shows one example of an implementation of a system for low data rate, low power, bi-directional transmissions in an RPD type HFC network 200. This HFC network 200 includes a headend/hub 210 coupled to an HFC node 214 using optical fiber 212 and includes RF amplifiers 240a-c coupled to the HFC node 214 using coaxial cables 216, similar to the HFC network 100 described above and shown in FIG. 1. In this embodiment of the HFC network 200, low data rate, low power, bi-directional transmissions may be implemented in the RF amplifiers 240a-c, for example, to communicate with a proactive network maintenance (PNM) system in the headend. In this embodiment of the HFC network 200, digital communication is provided over the optical fiber 212 between the headend 210 and the HFC node 214 and the HFC node 214 includes an RPD device 230 to handle the digital communications.

In this embodiment of the HFC network 200, the headend/hub 210 includes an integrated CMTS or Converged Cable Access Platform (CCAP) core 220 coupled to a converged interconnected network (CIN) 222. The CCAP core 220 and the CIN 222 provide digitized optical communication with the RPD 230 in the HFC node 214. The headend 210 also includes a gateway device 226 to establish the low data rate, low power bi-directional transmissions. The gateway device 226 may include, for example, a LoRa gateway processor and LoRa transceivers to communicate in accordance with the LoRa network architecture, protocols and frame format. In this embodiment, the analog low data rate, low power bi-directional transmissions are digitized for communication between the CIN 222 and the RPD 230 in the HFC node 214. The RPD 230 converts upstream signals from analog to digital and converts downstream signals from digital to analog, and the headend/hub 210 may include an out-of-band (OOB) core 224 coupled to the gateway device 226 to handle the A/D and D/A conversion in the headend 210 for the low data rate, low power bi-directional transmissions.

The OOB core 224 may use known technologies and standards in the DOCSIS R-PHY specifications referred to as the OOB (out-of-band) communication protocols, which are further defined in the remote out-of-band (CM-SP-R-OOB) specification. As defined in the CM-SP-R-OOB specification, Narrowband Digital Forward (NDF) and Narrowband Digital Return (NDR) digitizes a small portion of the spectrum and sends the digital samples as payload within packets that traverse between the CMTS/CCAP core 220 and the RPD 230. This approach works with any type of OOB signal as long as the signal can be contained within the defined pass bands.

In the embodiment of the HFC network 200 described above, the headend/hub 210 may include a proactive network maintenance (PNM) system 228 coupled to the CMTS 220 and the gateway device 226. The PNM system 228 may be used by cable operators to perform strategic maintenance of a network preemptively to avoid long outages and to have a more resilient and reliable broadband network. Commands and/or data used by the PNM system 228 may be transmitted and received via the low data rate, low power bi-directional transmissions established using the gateway device 226 to provide network maintenance. The PNM system 228 may include existing PNM systems known to those skilled in the art. The headend/hub 210 may use the gateway device 226 and the low data rate, low power bi-directional transmissions to communicate the commands and/or data for managing a large number of network devices, such as nodes and RF amplifiers, in the HFC network 200 using existing network management and control systems. The systems and methods for low data rate, low power bi-directional transmissions, consistent with embodiments of the present disclosure, thus provide a relatively simple, reliable, and low cost solution for monitoring, controlling, and managing broadband networks without detectable interference with the primary broadband signals.

In other embodiments, a headend virtual gateway may be used for providing low data rate, low power bidirectional transmissions, for example, in accordance with the LoRa network architecture, protocols and frame format. The headend virtual gateway may be implemented in software and may replace a hardware gateway device in the headend/hub 210. In further embodiments, a portable network communications module may be connected directly to an HFC node (e.g., HFC node 214) for providing low data rate, low power bidirectional transmissions, for example, in accordance with the LoRa network architecture, protocols and frame format. The portable network communications module, also referred to as a node gateway, may be configured similar to the gateway device 226 with a LoRa gateway processor and at least one LoRa transceiver. A computing device with a user interface may be connected to the headend 210, to a headend virtual gateway, and/or to a portable network communications module (a node gateway) to allow a user to trigger topology discovery and/or to obtain topology information such as a visual representation of the topology.

In the embodiments of the HFC networks 100, 200 described above, one type of low data rate, low power bidirectional transmissions may use spread-spectrum modulated signals that are positioned in frequency relative to the primary signals (e.g., multiplexed narrowband modulated signals), such that the low data rate, low power transmissions occur without detectable interference with the primary signals. The spread-spectrum signals may be transmitted with downstream primary signals, for example, at frequencies between 150 MHz to 960 MHz and with upstream primary signals, for example, at frequencies between 5 MHz to 85 MHz. The spread-spectrum modulated signals may be chirp spread spectrum (CSS) modulated signals modulated using Gaussian frequency shift keying (GFSK). GFSK modulation may be used at fixed frequencies with bandwidths up to 500 kHz, and the spread spectrum bandwidths may be from 7 kHz to 500 kHz. The use of spread spectrum technology reduces the chance of interference with or being interfered with by other signals (e.g., primary downstream and upstream signals). One example of the spread-spectrum modulated signals is implemented using LoRa technology and communication protocols defined by the LoRaWAN® standard.

In the embodiments of the HFC networks 100, 200 described above, another type of low data rate, low power bidirectional transmissions may use frequency shift keying (FSK) modulated signals. One example of the FSK modulated signals is implemented using the SCTE 25-1 standard defining the physical layer portion of the protocol stack used for communication between a headend element and HMS-compliant transponders.

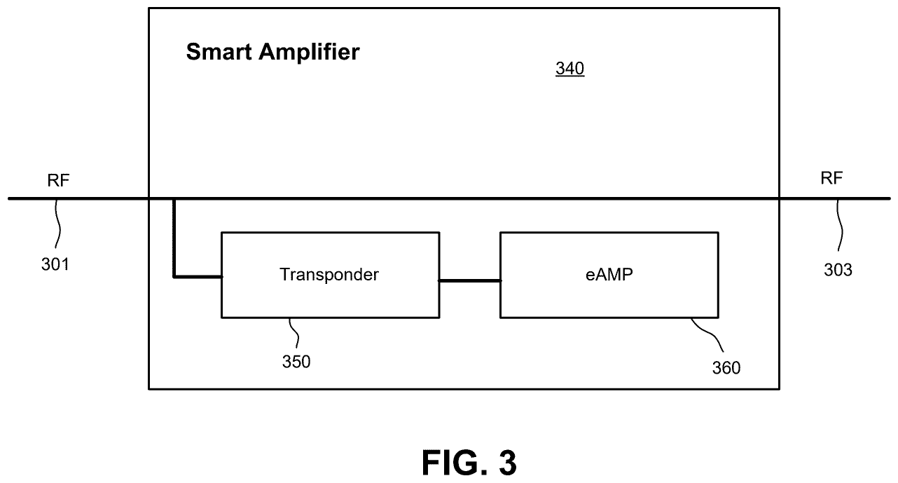

As shown in FIG. 3, an RF amplifier 340 (e.g., RF amplifiers 240a-c in HFC network 200 or RF amplifiers 340a-c in HFC network 300) may include a transponder 350 together with the electronic amplifier circuitry (eAMP) 360, consistent with embodiments of the present disclosure. The transponder 350 may provide low data rate, low power, bidirectional transmissions with a gateway (e.g., gateway device 226 in the headend 210), for example, to send data signals from the amplifier 340 to the headend/hub and/or to receive control signals from the headend/hub in the amplifier 340. The transponder 350 may also use low data rate, low power, bidirectional transmissions for topology discovery, as will be described in greater detail below.

The transponder 350 provides low data rate, low power, bidirectional transmissions together with the upstream and downstream primary signals over the coaxial cables 301, 303 coupled to the RF amplifier 340. Upstream and downstream channels carried over the coaxial cables 301, 303 may be separated inside the RF amplifier 340 on an upstream signal path and a downstream signal path. The downstream and upstream signal paths may be coupled to diplexers in the RF amplifier for separating and combining the downstream and upstream channels, which are carried together over the coaxial cables 301, 303. The transponder 350 may also provide bidirectional transmissions with other transponders located in other amplifiers or network devices in the HFC network.

The transponder 350 may use spread-spectrum modulated RF signals, such as CSS modulated signals or LoRa signals, to provide low data rate, low power, bidirectional transmissions. In particular, the transponder 350 may receive downstream RF signals (DS RF) from a gateway or headend controller using a downstream signal path in the RF amplifier 340 and may transmit upstream RF signals (DS RF) to the gateway or headend controller using an upstream signal path in the RF amplifier 340. By using spread-spectrum modulated signals, such as CSS modulated signals or LoRa signals, the transponder 350 may transmit and receive the RF signals using relatively low power, e.g., consuming less than 1 watt inside of the amplifier 340, which helps manage power consumption and head in the RF amplifier 340. The transponder 350 also provides a robust RF interface, for example, with more than 130 dB of dynamic range and the ability to recover signals up to 20 dB below the average noise.

In an embodiment, the transponder 350 may also provide low data rate, low power bidirectional transmissions using SCTE 25-1 signals instead of or in addition to LoRa signals, thereby providing dual out-of-band communications. This allows for simultaneous support for both LoRa based packet communication protocol and communications via the SCTE 25-1 hardware specification. The transponder 350 may include separate transceivers for the LoRaWAN® based packet mode and the SCTE 25-1 based serial mode or may include a single transceiver configured for both the LoRaWAN® based packet mode and the SCTE 25-1 based serial mode. In another embodiment, the transponder 350 may be configured to switch both transmit and receive functions between both upstream and downstream signal paths to facilitate communications directly with other amplifiers or other HFC network devices without using the headend or a gateway.

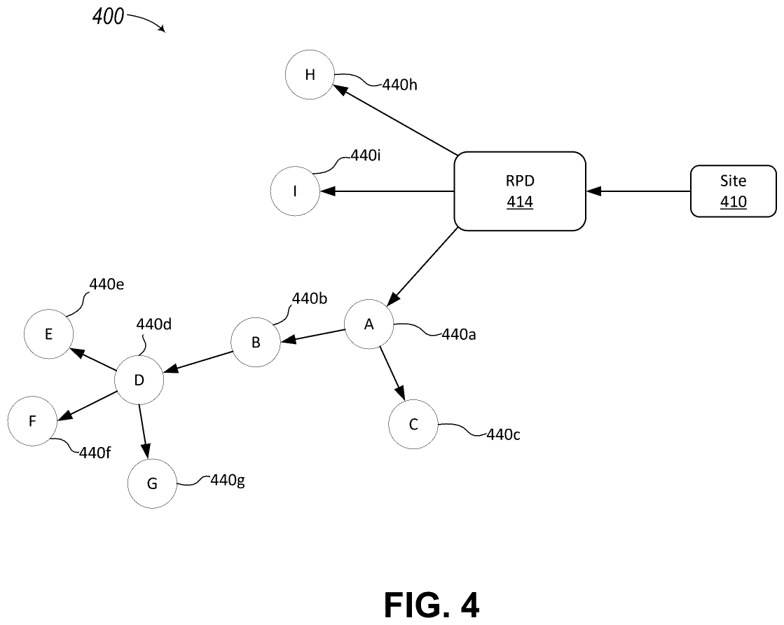

FIG. 4 illustrates one example of an HFC network 400 with connection points 440a-440i for RF amplifiers deployed in a cascading chain, which may be identified using topology discovery, consistent with the present disclosure. The HFC network 400 includes a site 410, such as a headend site or headend regional hub site, and a remote PHY device (RPD) 414, which may be located in an optical node as discussed above. The connection points 440a-440i may be connection points in a cable distribution network as discussed above.

The RF amplifiers connected within a cascading chain, e.g., at connection points 440a-g, may share some common properties. At the node level, the amplifiers connected within a chain may be connected to the same gateway, such as a virtual local gateway, and to the same RPD 414. At the session level, the amplifiers connected within a chain may be on the same Narrowband Digital Forward (NDF)/Narrowband Digital Return (NDR) channel. The RF amplifiers connected within a chain may also use a common protocol to communicate.

In this example, the connection point A 440a is higher up in the chain, whereas the connection point C 440c, the connection point E 440e, the connection point F 440f, and the connection point G 440g represent leaf connection points. The RF amplifiers located at these leaf connections points 440c, 440e, 440f, 440g are at the edge of the HFC network 400. Thus, the “impact” radius of the RF amplifier at connection point A 440a is higher than that of the RF amplifier at these leaf connections points 440c, 440e, 440f, 440g.

In an HFC network, the sequence of an RF amplifier in the cascading chain is important because RF amplifiers at leaf positions (e.g., connections points 440c, 440e, 440f, 440g) within the chain are less important than RF amplifiers at connection points (e.g., connection point 440a) higher up in the chain and closer to the remote PHY device (e.g., RPD 414). An RF amplifier failure in a leaf position will cause smaller disruption, but an RF amplifier failure occurring at the top of the chain has a larger impact radius down the chain. Thus, establishing the relative importance of each RF amplifier based on its position in the chain may aid cable operators to prioritize and assess the service impact of the RF amplifiers. This relative importance may be established through the discovery of the topology using systems and methods of topology discovery described herein. This discovery may significantly aid cable operators in terms of establishing a relative importance of the RF amplifiers, scheduling maintenance, and in understanding of the HFC network.

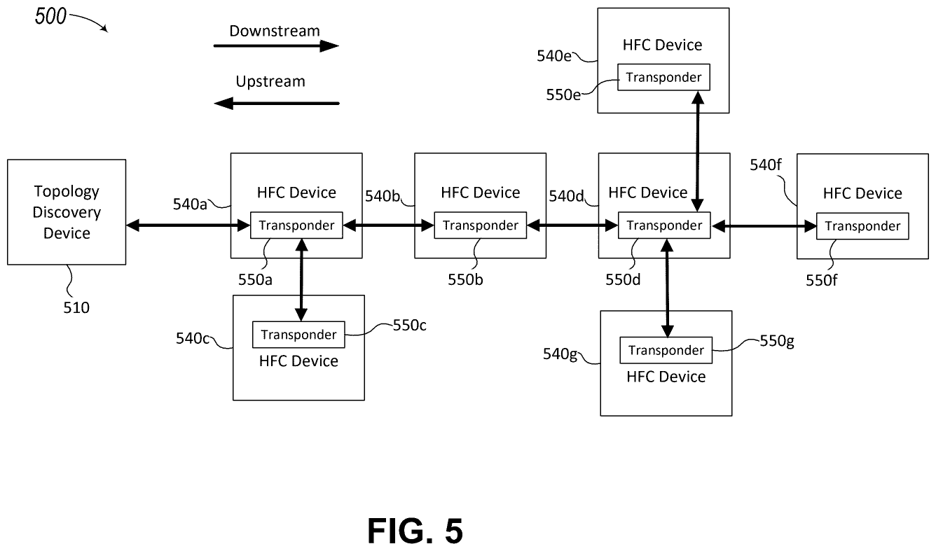

FIG. 5 illustrates a functional block diagram of a system 500 for topology discovery in an HFC network, for example, the HFC network 400 with RF amplifiers connected in a cascading chain. The system 500 for topology discovery includes a topology discovery device 510 (e.g., at the headend or a node gateway of the HFC network) that sends a broadcast message downstream for HFC devices 540a-g (e.g., the RF amplifiers) in the HFC network. The system 500 also includes transponders 550a-g in the HFC devices 540a-g that receive the broadcast message to initiate topology discovery. Topology discovery may be initiated automatically, for example, using a headend controller in the headend or may be triggered manually, for example, using a node gateway coupled to a node.

In response to receiving a broadcast message from the topology discovery device 510 initiating topology discovery, each of the transponders 550a-g sends an advertisement message upstream including at least a device unique identifier for the respective HFC device. For example, the transponder 550d in the HFC device 540d will send an advertisement message upstream with the unique identifier for the HFC device 540d. After one of the transponders 550a-g sends an advertisement message upstream, the transponder listens for advertisement messages from downstream transponders in HFC devices. The transponder 550d in the HFC device 540d, for example, will listen for advertisement messages sent by transponders 550e, 550f, 550g in downstream HFC devices 540e, 540f, 540g.

When one of the transponders 550a-g receives an advertisement message or packet from a transponder in a downstream HFC device, the transponder appends the received device unique identifier to a list of device unique identifiers maintained in storage in the transponder. The transponder 550d in the HFC device 540d, for example, will maintain a list of device unique identifiers for the downstream HFC devices 540e, 540f, 540g based on the advertisement messages sent by the transponders 550e, 550f, 550g. Each of the transponders may store the lists of device unique identifiers that it has discovered until a new topology discovery is initiated.

The transponders maintaining lists of device unique identifiers may send the lists to the topology discovery device 510 for compiling topology information based on the lists of device unique identifiers. In one example, a headend controller maintains the topology information discovered across all of the hub sites and RPDs connected to the headend controller, for example, in a persistent store in the headend controller. The topology discovery device 510 may compile the topology information by determining where each of the HFC devices 540a-g is located in the HFC network based on the lists of device unique identifiers and the HFC devices sending those lists. If the topology discovery device 510 receives a list of device unique identifiers for HFC devices 540e, 540f, 540g from the transponder 550d in the HFC device 540d, for example, but does not receive any lists of device unique identifiers from the HFC devices 540e, 540f, 540g, the topology discovery device 510 may determine that the HFC devices 540e, 540f, 540g are downstream from the HFC device 540d and the HFC devices 540e, 540f, 540g are at the edge of the HFC network.

Where the HFC devices 540a-g are RF amplifiers in an HFC network, the topology discovery device 510 will determine that these RF amplifier HFC devices 540e, 540f, 540g at the edge of the HFC network are less important than the upstream RF amplifier HFC device 540d. The topology discovery device 510 may assign numbers to the HFC devices 540a-g indicative of the relative importance and may also generate a visual representation of the topology, for example, using the assigned numbers. The visual representation may include, for example, a topology view diagram. A visual representation advantageously provides a clear and intuitive depiction of the structure, connections, and components of the HFC network. By visually mapping out the topology, network administrators can easily identify bottlenecks, potential points of failure, and areas for optimization. Visual representations also facilitate communication among team members, helping them understand complex network configurations and relationships more effectively. Moreover, visualizations enable quick troubleshooting and decision-making, enhancing overall network management and performance.

The topology discovery device 510 may be a computing device connected to the HFC devices 540a-g and configured to transmit broadcast messages to the HFC devices 540a-g to initiate topology discovery. In particular, the topology discovery device 510 may be programmed to implement remote multicast messaging to end-devices (i.e., the HFC devices 540a-g) over a LoRaWAN link, for example, according to the LoraWAN® standard defined in LoRaWAN® Remote Multicast Setup Specification TS005-2.0.0. The topology discovery device 510 may also be configured to process the lists of device unique identifiers and to compile topology information. In embodiments of an HFC network, the topology discovery device 510 may be a headend controller or may be a node gateway that is coupled to an optical node for purposes of communication with the HFC devices.

The transponders 550a-g may be transponders in RF amplifiers (e.g., transponder 350 in RF amplifier 340), which are configured to implement remote multicast messaging over a LoRaWAN link, for example, according to the LoraWAN® standard defined in LoRaWAN® Remote Multicast Setup Specification TS005-2.0.0. The transponders 550a-g may also be configured to both transmit and receive messages or packets both upstream and downstream to allow direct communication between the transponders 550a-g without using a headend or gateway.

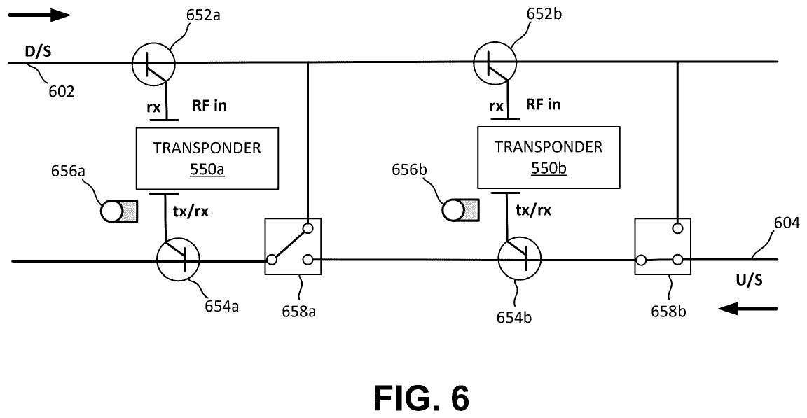

FIG. 6 shows two of the transponders 550a, 550b in the system 500 of FIG. 5 configured to switch between the transmit and receive function and to switch between a downstream signal path 602 and an upstream signal path 604, which allows the transponders 550a, 550b to both transmit packets to upstream devices and to receive packets from downstream devices. The transponders 550a, 550b are connected to the downstream signal path 602 and the upstream signal path 604 in the respective HFC devices 540a, 540b, for example, using RF splitters/combiners 652a, 652b, 654a, 654b. Each of the transponders 550a, 550b may be configured to transmit over the upstream signal path 604, for example, when sending advertisement messages upstream and to receive over the upstream signal path 604, for example, when listening for advertisement messages sent from downstream devices.

In order to support bidirectional communications over both the downstream and upstream directions, the transponder 650a includes first and second switches 654a, 658a and transponder 650b includes first and second switches 654b, 658b. In an embodiment, the switches 654a, 654b, 658a, 658b may be SPDT (Single Pole Double Throw) switches and may be controlled by software. The first switch 654a, 654b toggles between transmitting and receiving at the respective transponder 550a, 550b. The second switch 658a, 658b may be software controlled to switch between the downstream path 602 and the upstream path 605. The switches 654a, 654b, 658a, 658b thus allow the transponders 550a, 550b to communicate directly with each other without using the headend or a gateway. Thus, the transponder 550a may be switched to transmit over the upstream path 604 in a transmit mode when transmitting advertisement messages and may be switched to receive over the upstream path 604 in a listening mode when listening for advertisement messages sent from downstream devices, e.g., from transponder 550b. The second switch 658a, 658b allows the transponder 550a, 550b to also transmit over the downstream path 602.

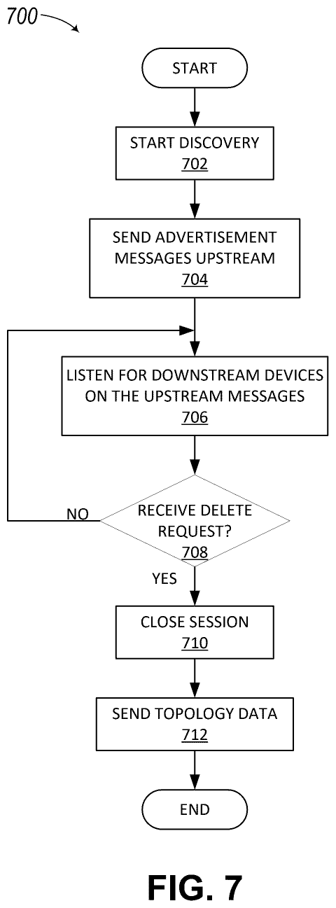

Referring to FIG. 7, a method 700 for topology discovery using the system 500 is described in greater detail. To initiate a topology discovery mode (operation 602), the topology discovery device 510 sends a multicast message downstream to the HFC devices 540a-g. For example, the topology discovery device 510 may first send a unicast message to the HFC devices 540a-g in a cascading chain to set up a multicast group, for example, using a McGroupSetupReq command as defined in the LoRaWAN® Remote Multicast Setup Specification TS005-2.0.0. In this example, the McGroupSetupReq command includes a multicast group ID (McGroupID), which may be an integer in the range of [0:3], and each of the HFC devices 540a-g may be part of up to 4 multicast groups.

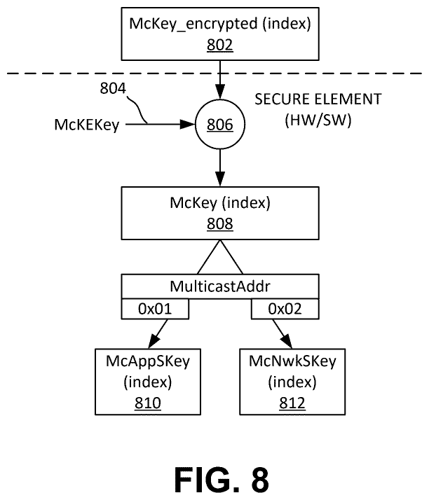

The discovery may be performed over an encrypted session. In the example embodiment, the McGroupSetupReq command may include an encrypted multicast group key (McKey_encrypted) 802 from which a McAppSKey 810 and McNwkSKey 812 are derived, as shown in FIG. 8 and described further in the LoRaWAN® Remote Multicast Setup Specification TS005-2.0.0. The McKEKey 804 is a lifetime end-device specific key used to encrypt a multicast key transported over the air (i.e., a Key Encryption Key). The McKEKey 804 is used by AESencrypt 806 to generate a McKey 804 using 128-bit AES encryption. The McAppSKey 810 and McNetSKey 812 are then derived from the McKey 804 and the multicast address, which is the four octets network address of the multicast group, common to all end-devices of the group.

Once the multicast group is set up, the topology discovery device 510 may send a session request to HFC devices 540a-g in the multicast group to setup a multicast session, for example, using a McClassCSessionReq command as defined in the LoRaWAN® Remote Multicast Setup Specification TS005-2.0.0. The session request may describe a time window during which topology discovery will be performed and may specify a frequency for the multicast session.

After setting up a multicast group and session, the topology discovery device 510 may send the multicast message to trigger discovery. The real-time clocks of the HFC devices 540a-g may be synchronized to support the multicast message, for example, according to the LoRaWAN® Application Layer Clock Synchronization Specification TS003-2.0.0. The multicast message payload may include the Frame Type specifying the type of message being transmitted (e.g., FType=b′011′ Unconfirmed Data Downlink), the Frame Port indicating the type of data (e.g., FPort=75), and a mobility domain ID (e.g., QLCmdId=201). The multicast message payload may also include a duration, for example, encoding the maximum length in BeaconPeriods (128 seconds) of the multicast fragmentation session (e.g., 128*2\hat{ }duration seconds). The multicast message payload may further include a resend-delay in seconds, which is used to determine how often an end device will resend an advertisement message in response, as will be described below.

In response to receiving the multicast message from the topology discovery device 510, each of the HFC devices 540a-g (e.g., in the multicast group) sends advertisement messages upstream (operation 704). Each of the advertisement messages includes at least a device unique identifier, such as the device extended unique identifier (DevEUI) assigned to end devices in a LoraWAN® network. For example, each of the HFC devices 540a-g in a multicast group receiving a multicast message may determine a random time delay and may periodically send advertisement messages as a function of the random time delay until the multicast session closes. The time delay may be determined based on the resend-delay specified in the multicast message plus a random time. The advertisement message payload may include the Frame Type (e.g., FType=b′010′ Unconfirmed Data Uplink), the Frame Port (e.g., FPort=75), the mobility domain ID (e.g., QLCmdId=201), and the device extended unique identifier (DevEUI).

After one of the HFC devices 540a-g sends an advertisement message, the HFC device listens for advertisement messages sent upstream by downstream HFC devices (operation 706). For example, the transponder in the HFC device may switch to listening mode on an upstream signal path and switch to the frequency specified in the multicast message to listen for advertisement messages on the upstream path. In the illustrated system 500, for example, after the HFC device 540b sends an advertisement message upstream, the HFC device 540b will listen for advertisement messages sent upstream from downstream HFC devices 540d, 540e, 540f, and 540g. If the HFC device listening for upstream advertisement messages needs to transmit upstream (e.g., in response to a query or command from the headend or if a timer expires for sending statistics to the headend), the HFC device may switch to the transmit mode on the upstream signal path and then may switch back to the listening mode.

One or more of the HFC devices 540a-g also maintain a list of device unique identifiers based on the advertisement messages received from downstream HFC devices. For example, responsive to receiving an advertisement message from a downstream HFC device, the HFC device appends the device unique identifier included in the advertisement message received from the downstream HFC device to the list of device unique identifiers stored in the transponder. In the illustrated system 500, for example, the HFC device 540b maintains a list of device unique identifiers for HFC devices 540d, 540e, 540f, and 540g. When an HFC device receives a new multicast message to trigger a new topology discovery, the transponder will clear any list of device unique identifiers received from downstream HFC devices and start a new list.

The topology discovery device 510 may send a command to exit topology discovery mode and/or send a query to request topology data from HFC devices that maintain a list of device unique identifiers. To exit topology discovery mode (operation 708), for example, the topology discovery device 510 may send a McGroupDeleteReq command as defined in the LoRaWAN® Remote Multicast Setup Specification TS005-2.0.0. In response to receiving a command to exit topology discovery mode, the transponder in the HFC device will close the session (operation 710) and will send the list of device unique identifiers currently stored by the transponder to the topology discovery device 510 (operation 712). The message payload may include, for example, the Frame Type (e.g., FType=b′100′ Confirmed Data Uplink), the Frame Port (e.g., FPort=75), the mobility domain ide (e.g., QLCmdId=201), a Count, and the list of unique device identifiers (e.g., DevEUI []). The HFC device may resend this message a predetermined number of times (e.g., at least 5 times) with a randomized delay until acknowledgement is received from the topology discovery device 510.

The topology discovery device 510 may also send a query to request topology data from HFC devices at any time by sending a confirmed data downlink. This topology request message payload may include, for example, the Frame Type (e.g., FType=b′101′ Confirmed Data Downlink), the Frame Port (e.g., FPort=75) and the mobility domain ID (e.g., QLCmdId=201). In response to a request for topology data, the HFC device may send a confirmed data uplink message including the list of device unique identifiers, as discussed above.

Accordingly, systems and methods for topology discovery in an HFC network, consistent with the present disclosure, allow discovery of HFC devices, such as RF amplifiers in the network, without interfering with primary signals in the HFC network. Such systems and methods for topology discovery allow a user, such as a network administrator, to visualize the HFC network topology and to assess the relative importance of HFC devices, such as RF amplifiers, in the HFC network.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto.

Embodiments of the methods described herein may be implemented using a controller, processor, and/or other programmable device. To that end, the methods described herein may be implemented on a tangible, non-transitory computer readable medium having instructions stored thereon that when executed by one or more processors perform the methods. The storage medium may include any type of tangible medium, for example, any type of disk optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic instructions.

It will be appreciated by those skilled in the art that any block diagrams herein represent conceptual views of illustrative circuitry embodying the principles of the disclosure. Similarly, it will be appreciated that any block diagrams, flow charts, flow diagrams, state transition diagrams, pseudocode, and the like represent various processes which may be substantially represented in computer readable medium and so executed by a computer or processor, whether or not such computer or processor is explicitly shown. Software modules, or simply modules which are implied to be software, may be represented herein as any combination of flowchart elements or other elements indicating performance of process steps and/or textual description. Such modules may be executed by hardware that is expressly or implicitly shown.

The functions of the various elements shown in the figures, including any functional blocks labeled as a controller or processor, may be provided through the use of dedicated hardware as well as hardware capable of executing software in association with appropriate software. The functions may be provided by a single dedicated processor, by a single shared processor, or by a plurality of individual processors, some of which may be shared. Moreover, explicit use of the term controller or processor should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

The term “coupled” as used herein refers to any connection, coupling, link, or the like by which signals carried by one system element are imparted to the “coupled” element. Such “coupled” devices, or signals and devices, are not necessarily directly connected to one another and may be separated by intermediate components or devices that may manipulate or modify such signals.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems. Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements.

Although the methods and systems have been described relative to a specific embodiment thereof, they are not so limited. Obviously, many modifications and variations may become apparent in light of the above teachings. Many additional changes in the details, materials, and arrangement of parts, herein described and illustrated, may be made by those skilled in the art.

What is claimed is:

1. A method for topology discovery in a hybrid fiber-coaxial (HFC) network, the method comprising:
sending, from a topology discovery device, a multicast message downstream to a plurality of HFC devices connected in a cascading chain in the HFC network to initiate a topology discovery mode;
sending advertisement messages upstream from the HFC devices in response to receiving the multicast message, wherein each of the advertisement messages includes at least a device unique identifier for the HFC device sending the advertisement message;
listening, at the HFC devices that send advertisement messages, for the advertisement messages sent upstream from downstream HFC devices; and
maintaining a list of device unique identifiers based on the advertisement messages received from downstream HFC devices.

2. The method of claim 1, wherein the topology discovery device includes a headend controller in a headend of the HFC network.

3. The method of claim 1, wherein the topology discovery device includes a node gateway connected to an optical node of the HFC network.

4. The method of claim 1, wherein the HFC devices include RF amplifiers in the HFC network.

5. The method of claim 1, wherein each of the HFC devices include a transponder configured to send the advertisement messages, to listen for the advertisement messages, and to maintain the list of device unique identifiers.

6. The method of claim 1, wherein sending the multicast message from the topology discovery device to the plurality of HFC devices in the HFC network further comprises:
sending a unicast message from the topology discovery device to the plurality of HFC devices to setup a multicast group;
sending a session request to HFC devices in the multicast group of the plurality of HFC devices to setup a multicast session, wherein the session request describes a time window during which the topology discovery will be performed; and
sending the multicast message to the multicast group during the multicast session.

7. The method of claim 6, wherein sending the advertisement messages upstream from the HFC devices in response to receiving the multicast message comprises:
determining a random time delay; and
periodically sending advertisement messages as a function of the random time delay until the multicast session closes.

8. The method of claim 6, wherein listening at the HFC devices comprises:
switching to listening mode in response to sending an advertisement message; and
switching to a frequency specified in the session request.

9. The method of claim 6, wherein maintaining a list of device unique identifiers based on the advertisement messages received from downstream devices comprises:
responsive to receiving an advertisement message from a downstream HFC device, appending the device unique identifier included in the advertisement message received from the downstream HFC device to the list of device unique identifiers.

10. The method of claim 1, wherein the list of device unique identifiers is maintained in each of the HFC devices listening and receiving the advertisement messages sent upstream from the downstream HFC devices.

11. The method of claim 10, further comprising:
sending a request for topology data from the topology discovery device to the plurality of HFC devices; and
in response to receiving the request for topology data, sending the list of device unique identifiers to the topology discovery device from each of the HFC devices maintaining a list of device unique identifiers.

12. The method of claim 11, wherein sending the request for topology data includes sending a multicast group delete request to exit topology discovery mode.

13. The method of claim 10, further comprising:
clearing the list of device unique identifiers maintained in the HFC devices in response to receiving a new multicast message.

14. A system for topology discovery in a hybrid fiber-coaxial (HFC) network, the system comprising:
a topology discovery device configured to send a multicast message downstream in the HFC network to initiate a topology discover mode; and
a plurality of HFC devices connected in a cascading chain in the HFC network, wherein each of the HFC devices include at least one transponder configured to:
send advertisement messages upstream from the HFC device in response to receiving the multicast message, wherein each of the advertisement messages includes at least a device unique identifier for the HFC device sending the advertisement message;
listen for the advertisement messages sent upstream from downstream HFC devices; and
maintain a list of device unique identifiers based on the advertisement messages received from downstream HFC devices.

15. The system of claim 14, wherein the topology discovery device includes a headend controller in a headend of the HFC network.

16. The system of claim 14, wherein the topology discovery device includes a node gateway connected an optical node of the HFC network.

17. The system of claim 14, wherein the topology discovery device and the transponder in each of the HFC devices are configured to send and receive messages for topology discovery according to the LoraWAN® remote multicast setup specification TS005.

18. The system of claim 14, wherein the HFC devices include RF amplifiers in the HFC network.

19. The system of claim 14, wherein the topology discovery device is also configured to send a request for topology data from the topology discovery device to the plurality of HFC devices, and wherein the transponder in each of the HFC devices is configured to send the list of device unique identifiers to the topology discovery device in response to receiving the request for topology data.

20. The system of claim 19, wherein the topology discovery device is a headend controller, wherein the headend controller is configured to receive the lists of device unique identifiers from the HFC devices and to maintain topology information based on the lists of device unique identifiers received from the HFC devices.

21. The system of claim 20, wherein the HFC devices include RF amplifiers in the HFC network, and wherein the headend controller is configured to determine a relative importance of each of the RF amplifiers in the HFC network based on a location in the cascading chain as determined from the lists of device unique identifiers received from the RF amplifiers.

22. The system of claim 21, wherein the headend controller is configured to assign a number to the RF amplifiers based on the relative importance.

23. The system of claim 20, wherein the headend controller is configured to provide a visual representation of the topology information.

24. The system of claim 20, wherein the headend controller is configured to automatically initiate the topology discovery mode.
